(19) United States
(12) Patent Application Publication
(10) Pub. No.: US 2026/0236053 A1
(43) Pub. Date: Aug. 13, 2026

(54) LOW DROPOUT (LDO) NFET VOLTAGE REGULATOR USING THIN OXIDE DEVICES

(71) Applicant: QUALCOMM Incorporated, San Diego, CA (US)

(72) Inventors: Ashwith Jerome REGO, Bangalore (IN); Raghav GUPTA, Bangalore (IN); Baibhav KUMAR, Bengaluru (IN); Mohammad Wasim SAYED, Bangalore (IN); Abhinav MURALI, Bangalore (IN); Burcin Serter ERGUN, Poway, CA (US); Sajin MOHAMAD, San Diego, CA (US); Zhiqin CHEN, San Diego, CA (US)

(21) Appl. No.: 19/050,752

(22) Filed: Feb. 11, 2025

(51) Int. Cl. G05F 1/595; G05F 1/575

(52) U.S. Cl. CPC G05F 1/595; G05F 1/575

(57) ABSTRACT

A voltage regulator including a first PFET including a gate configured to receive a first control signal; a second PFET including a gate configured to receive a first bias voltage; a first NFET, wherein the first PFET, the second PFET, and the first NFET are coupled in series between a first upper voltage rail and an output; an operational amplifier including a first input configured to receive a reference voltage; a voltage boost circuit including an input coupled to an output of the operational amplifier and an output coupled to a gate of the first NFET; a second NFET including a gate configured to receive a second bias voltage; and a third NFET coupled in series with the second NFET between a node between the second PFET and the first NFET and a lower voltage rail, wherein the third NFET includes a gate configured to receive a second control signal.

### FIELD

This disclosure relates generally to voltage regulators, and in particular, to a low dropout (LDO) n-channel field effect transistor (NFET) voltage regulator using thin oxide devices.

### BACKGROUND

Low dropout (LDO) voltage regulators are used in many applications to provide a regulated output voltage for supplying power to many different types of circuits. The LDO voltage regulator generates the regulated output voltage from a supply voltage on a power or voltage rail. Often, the power rail supply voltage has significant noise, as it may also be coupled to or affected by other circuits performing high speed, current-demanding operations. Such high speed, current-demanding operations generate high frequency noise on the power rail, which may couple to noise-sensitive circuits, such as a voltage controlled oscillator (VCO) if the LDO voltage regulator were not present. The LDO voltage regulator provides a cleaner (less-noisy) output voltage for noise-sensitive circuits, such as a VCO.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to a low dropout (LDO) voltage regulator. The LDO voltage regulator includes: a first p-channel field effect transistor (PFET) including a gate configured to receive a first control signal; a second PFET including a gate configured to receive a first bias voltage; a first n-channel field effect transistor (NFET), wherein the first PFET, the second PFET, and the first NFET are coupled in series between a first upper voltage rail and an output of the LDO voltage regulator; an operational amplifier including a first input configured to receive a reference voltage; a voltage boost circuit including an input coupled to an output of the operational amplifier and an output coupled to a gate of the first NFET; a second NFET including a gate configured to receive a second bias voltage; and a third NFET coupled in series with the second NFET between a node and a lower voltage rail, wherein the node is between the second PFET and the first NFET, wherein the third NFET includes a gate configured to receive a second control signal.

Another aspect of the disclosure relates to a method of operating a low dropout (LDO) voltage regulator. The method includes: in an active mode of operation: turning on a first p-channel field effect transistor (PFET) and a second PFET coupled in series between an upper voltage rail and a first n-channel field effect transistor (NFET); applying a first regulation voltage to a gate of the first NFET to generate an output voltage at a source of the first NFET; and in a power down mode of operation: turning off the first and second PFETs; and turning on the second and third NFETs.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example phase locked loop (PLL) in accordance with an aspect of the disclosure.

FIG. 2A illustrates a block/schematic diagram of an example low dropout (LDO) voltage regulator in an active mode of operation in accordance with another aspect of the disclosure.

FIG. 2B illustrates a block/schematic diagram of the example low dropout (LDO) voltage regulator of FIG. 2A in a power down mode of operation in accordance with another aspect of the disclosure.

FIG. 3 illustrates a block/schematic diagram of another example low dropout (LDO) voltage regulator in an active mode of operation in accordance with another aspect of the disclosure.

FIG. 4A illustrates a block/schematic diagram of another example low dropout (LDO) voltage regulator in an active mode of operation in accordance with another aspect of the disclosure.

FIG. 4B illustrates a block/schematic diagram of the example low dropout (LDO) voltage regulator of FIG. 4A in a power down mode of operation in accordance with another aspect of the disclosure.

FIG. 5A illustrates a block/schematic diagram of another example low dropout (LDO) voltage regulator in an active mode of operation in accordance with another aspect of the disclosure.

FIG. 5B illustrates a block/schematic diagram of the example low dropout (LDO) voltage regulator of FIG. 5A in a power down mode of operation in accordance with another aspect of the disclosure.

FIG. 6A illustrates a block/schematic diagram of another example low dropout (LDO) voltage regulator in an active mode of operation in accordance with another aspect of the disclosure.

FIG. 6B illustrates a block/schematic diagram of the example low dropout (LDO) voltage regulator of FIG. 6A in a disabled or HiZ mode of operation in accordance with another aspect of the disclosure.

FIG. 7 illustrates a block/schematic diagram of another example low dropout (LDO) voltage regulator in VDDA_HV collapse situation in accordance with another aspect of the disclosure.

FIG. 8 illustrates a block/schematic diagram of another example low dropout (LDO) voltage regulator in VDDA collapse situation in accordance with another aspect of the disclosure.

FIG. 9 illustrates a block/schematic diagram of another example low dropout (LDO) voltage regulator in accordance with another aspect of the disclosure.

FIG. 10 illustrates a flow diagram of an example method of generating an output voltage in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. The term “substantially” means that the associated parameter may not be exact as indicated but accounts for some variation due to specified tolerances.

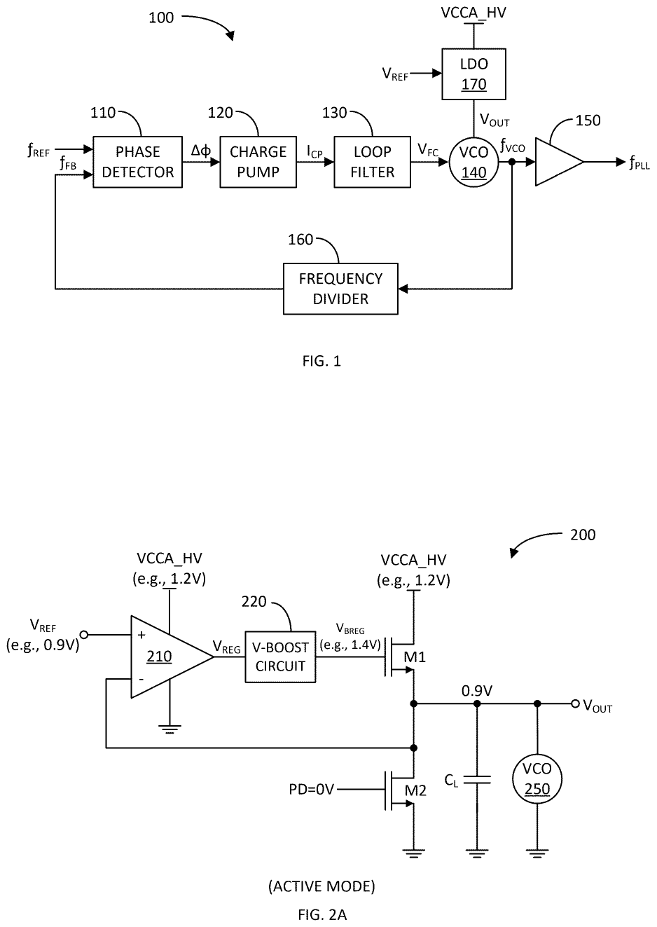

FIG. 1 illustrates a block diagram of an example phase locked loop (PLL) 100 in accordance with an aspect of the disclosure. The PLL 100 serves as an example to which a low dropout (LDO) voltage regulator 170 provides a regulated output voltage V_{OUT}. It shall be understood that the LDO voltage regulators described herein may provide regulated output voltages to many different types of circuits. The PLL 100 includes a phase detector 110, a charge pump 120, a loop filter 130, a voltage controlled oscillator 140, a buffer 150, and a frequency divider 160. Additionally, and of particular interest, the PLL 100 includes a low dropout (LDO) voltage regulator 170.

The phase detector 110 is configured to generate a phase error signal Δφ based on a phase difference between a reference clock signal f_{REF} and a feedback clock signal f_{FB}. The charge pump 120 is configured to generate a current signal I_{CP} based on the phase error signal Δφ. The loop filter 130 is configured to filter (e.g., low or band pass filter) the current signal I_{CP} to generate a frequency-control voltage signal V_{FC} for the VCO 140. The VCO 140 is configured to generate a VCO clock signal f_{VCO} whose frequency is controlled by the frequency-control voltage signal V_{FC}. The frequency divider 160 is configured to frequency divide the VCO clock signal f_{VCO} to generate the feedback clock signal f_{FB}. The buffer 150 is configured to buffer the VCO clock signal f_{VCO} to generate an output clock f_{PLL} of the PLL 100.

As shown, the LDO voltage regulator 170 is coupled between a power or voltage rail VCCA_HV and the VCO 140. The LDO voltage regulator 170 is configured to generate a regulated supply voltage V_{OUT} for supplying power to the VCO 140. The LDO voltage regulator 170 may generate the regulated supply voltage V_{OUT} based on a “noisy” supply voltage VCCA_HV and a substantially temperature-stable reference voltage V_{REF} (e.g., a bandgap voltage).

As previously discussed, the power rail VCCA_HV may supply power, not only to the VCO 140, but also to other circuits. In such configuration, the operations of the other circuits typically produce noise on the power rail. The LDO voltage regulator 170 typically filters out most of the power supply noise to generate the regulated output voltage V_{OUT} for the VCO 140. Accordingly, the VCO 140 is configured to generate the VCO clock signal f_{VCO} with reduced phase noise based on the regulation operation of the LDO voltage regulator 170.

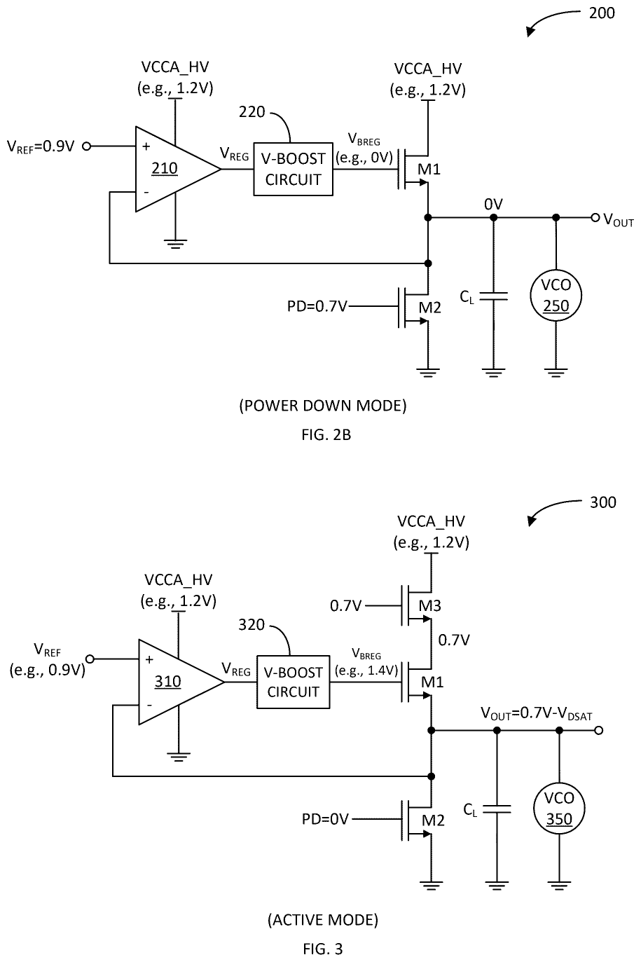

FIG. 2A illustrates a block/schematic diagram of an example low dropout (LDO) voltage regulator 200 in an active mode of operation in accordance with another aspect of the disclosure. The LDO voltage regulator 200 includes an operational amplifier 210, a voltage boost (V-boost) circuit 220, and an n-channel field effect transistor (NFET) M1 serving as the pass transistor for the LDO voltage regulator 200.

The operational amplifier 210 includes a first (e.g., positive) input configured to receive a reference voltage V_{REF} (e.g., 0.9V). The operational amplifier 210 includes a second (e.g., negative) input coupled to a source of the pass NFET M1, which may also serve as an output of the LDO voltage regulator 200 where a regulated output voltage V_{OUT} is generated. In this case, the second (e.g., negative input) of the operational amplifier 210 is coupled directly to the output of the LDO voltage regulator 200 where the regulated output voltage V_{OUT} is substantially equal to the reference voltage V_{REF} in the active mode (e.g., V_{OUT}=V_{REF}=0.9V). However, it shall be understood that the second (e.g., negative input) of the operational amplifier 210 may be coupled to an intermediate node of a voltage divider including resistors RA and RB coupled in series between the output of the LDO voltage regulator 200 and a lower voltage rail (e.g., ground). In such case, the regulated output voltage V_{OUT} may be given by the following equation: V_{OUT}=V_{REF}*(1+RA/RB), where RA and RB also represent the resistances of resistors RA and RB, respectively. The operational amplifier 210 may be coupled between an upper voltage rail VCCA_HV (e.g., 1.2V) and a lower voltage rail (e.g., ground).

The voltage boost circuit 220 includes an input coupled to an output of the operational amplifier 210. The voltage boost circuit 220 is configured to boost a regulation voltage V_{REG} (e.g., <1.2V) generated by the operational amplifier 210 to generate a boosted regulation voltage V_{BREG} (e.g., around 1.4V) to drive the gate of the pass NFET M1. The NFET M1 includes a drain coupled to the upper voltage rail VCCA_HV. The LDO voltage regulator 200 may include a pull-down NFET M2 including a drain coupled to the output of the LDO voltage regulator 200, a gate configured to receive a power down (PD) voltage, and a source coupled to the lower voltage rail. A load, such as a VCO 250 and a load capacitor C_{L}, may be coupled between the output of the LDO voltage regulator 200 and the lower voltage rail.

In recent process nodes, thick-oxide FETs may not be available. These thick-oxide devices may be able to reliably handle voltages across any terminal above the 1.2V of the upper voltage rail VCCA_HV. However, only thin-oxide FETs may only be available in certain process nodes. These thin-oxide devices may only reliably handle at most 1.0V across any pair of terminals of the device. If NFETs M1 and M2 of LDO voltage regulator 200 are thin-oxide devices, there may be a reliability issue with these devices, especially in power down (PD) mode of operation as discussed further herein.

In active mode, as shown in FIG. 2A, the NFETs M1 and M2 may operate within the 1.0V reliability. For example, with regard to NFET M1, its drain has a voltage at VCCA_HV of 1.2V. The NFET M1 has a gate with a voltage of around 1.4V generated by the voltage boost circuit 220. And, the NFET M1 has a source at the output of the LDO voltage regulator 200 at 0.9V. Thus, the drain-to-gate voltage V_{DG} of NFET M1 is 0.2V, the gate-to-source voltage V_{GS} of the NFET M1 is 0.5V, and the drain-to-source voltage V_{DS} of the NFET M1 is 0.3V. Thus, the voltage across all terminals of the NFET M1 are within the 1.0V reliability limit. All voltages across terminals of devices described herein are referred to as their absolute values for ease of description.

Similarly, with regard to the pull-down NFET M2, its drain has a voltage of V_{OUT}=0.9V. The NFET M2 has a gate with a deasserted pull-down (PD) voltage of 0V. And, the NFET M2 has a source at the lower voltage rail of 0V. Thus, the drain-to-gate voltage V_{DG} of NFET M2 is 0.9V, the gate-to-source voltage V_{GS} of the NFET M2 is 0V, and the drain-to-source voltage V_{DS} of the NFET M2 is 0.9V. Thus, the voltages across all terminals of the NFET M2 are within the 1.0V reliability limit.

FIG. 2B illustrates a block/schematic diagram of the example LDO voltage regulator 200 in a power down (PD) mode of operation in accordance with another aspect of the disclosure. In power down mode, the voltage boost circuit 220 is disabled, and thus, outputs 0V. Also, in power down mode, the PD voltage applied to the gate of the NFET M2 is 0.7V to turn on the pull-down NFET M2 and pull-down the output voltage V_{OUT} to 0V.

In power down mode, the reliability limit of 1.0V of NFET M1 is exceeded. For example, the NFET M1 includes a drain voltage at VCCA_HV of 1.2V. The NFET M1 has a gate voltage of 0V. The NFET M1 has a source voltage at the output of the LDO voltage regulator 200 at 0V. Thus, the drain-to-gate voltage V_{DG} of NFET M1 is 1.2V, the gate-to-source voltage V_{GS} of the NFET M1 is 0V, and the drain-to-source voltage V_{DS} of the NFET M1 is 1.2V. Thus, the V_{DG} and V_{DS} of NFET M1 are each 1.2V, exceeding the reliability limit of 1.0V. The reliability of the pull-down NFET M2 is met as the voltage across any terminals of the NFET M2 is no more than 0.7V.

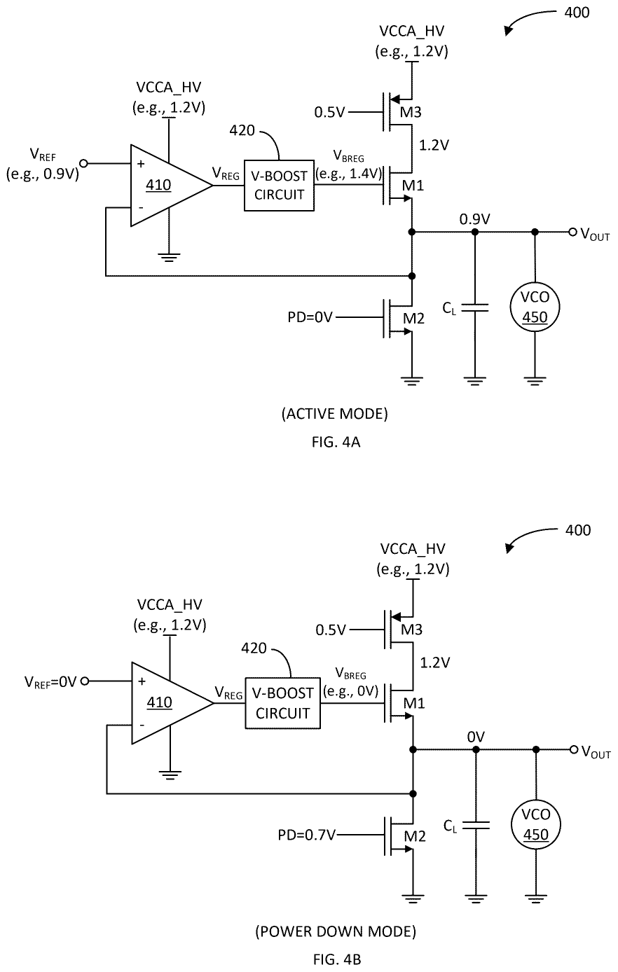

FIG. 3 illustrates a block/schematic diagram of another example low dropout (LDO) voltage regulator 300 in an active mode of operation in accordance with another aspect of the disclosure. The LDO voltage regulator 300 is similar to LDO voltage regulator 200 and includes many of the same/similar elements as indicated by the same reference identifiers and numbers with the most significant digit being a “3” for LDO voltage regulator 300 instead of a “2” for LDO voltage regulator 200.

The LDO voltage regulator 300 further includes a protection NFET M3 coupled between the upper voltage rail VCCA_HV and the pass NFET M1. In particular, the protection NFET M3 includes a drain coupled to the upper voltage rail VCCA_HV, a gate configured to receive a bias voltage of 0.7V, and a source coupled to a drain of the pass NFET M1. In active mode, the protection NFET M3 may protect the pass NFET M1 from exceeding its reliability voltage. For example, the largest voltage across any terminal of the pass NFET M1 may be its gate-to-source voltage V_{GS} being 1.4V-0.7V-V_{DSAT} (e.g., 0.1V), which may be about 0.8V, which is within the reliability limit of 1.0V. V_{DSAT} is the minimum saturation voltage (e.g., the lowest voltage across the drain and source of the NFET M1 at which the device enters the saturation region).

However, the LDO voltage regulator 300 fails to achieve the required output voltage of 0.9V as the output voltage V_{OUT} in this example may be about 0.6V (e.g., 0.7V−V_{DSAT} (0.1V)=0.6V). Thus, although the protection NFET M3 protects the pass NFET M1 from overvoltage, the output voltage V_{OUT} is out-of-spec; and thus, this may not be a workable solution for the LDO voltage regulator 300.

FIG. 4A illustrates a block/schematic diagram of another example low dropout (LDO) voltage regulator 400 in an active mode of operation in accordance with another aspect of the disclosure. The LDO voltage regulator 400 is similar to LDO voltage regulator 200 and includes many of the same/similar elements as indicated by the same reference identifiers and numbers with the most significant digit being a “4” for LDO voltage regulator 400 instead of a “2” for LDO voltage regulator 200.

The LDO voltage regulator 400 further includes a protection p-channel field effect transistor (PFET) M3 coupled between the upper voltage rail VCCA_HV and the pass NFET M1. In particular, the protection PFET M3 includes a source coupled to the upper voltage rail VCCA_HV, a gate configured to receive a bias voltage of 0.5V, and a drain coupled to the drain of the pass NFET M1.

In such active mode configuration, the protection PFET M3 protects the pass NFET M1 from overvoltage. For example, the gate of the protection PFET M3 being 0.5V turns on the protection PFET M3. Accordingly, the 1.2V at the upper voltage rail voltage VCCA_HV propagates through the protection PFET M3 to the drain of the pass NFET M1. Thus, the voltages at the drain, gate, and source of the pass NFET M1 are 1.2V, 1.4V, and 0.9V, respectively. Thus, the largest voltage across any terminal of the pass NFET M1 is its gate-to-source voltage V_{GS} of 0.5V. Thus, the protection PFET M3 protects the pass NFET M1 from overvoltage. Similarly, the voltage across any terminals of the protection PFET M3 and the pull-down NFET M2 are also within the reliability limit of 1.0V.

FIG. 4B illustrates a block/schematic diagram of the example LDO voltage regulator 400 in a power down mode of operation in accordance with another aspect of the disclosure. The protection PFET M3, with a gate voltage still at 0.5V, remains turned on in power down (PD) mode. Thus, the upper voltage rail voltage VCCA_HV propagates through the protection PFET M3 to the drain of the pass NFET M1. As previously discussed, in power down (PD) mode, the voltage boost circuit 420 outputs 0V. And the pull-down NFET M2, which now has a gate voltage of 0.7V, is turned on to pull down the output voltage V_{OUT} of the LDO voltage regulator 400 to 0V. Thus, the voltages at the drain, gate, and source of the pass NFET M1 are 1.2V, 0V, and 0V. Thus, the drain-to-gate voltage V_{GD} and drain-to-source voltage V_{DS} of the pass NFET M1 are both at 1.2V, exceeding the reliability limit of 1.0V.

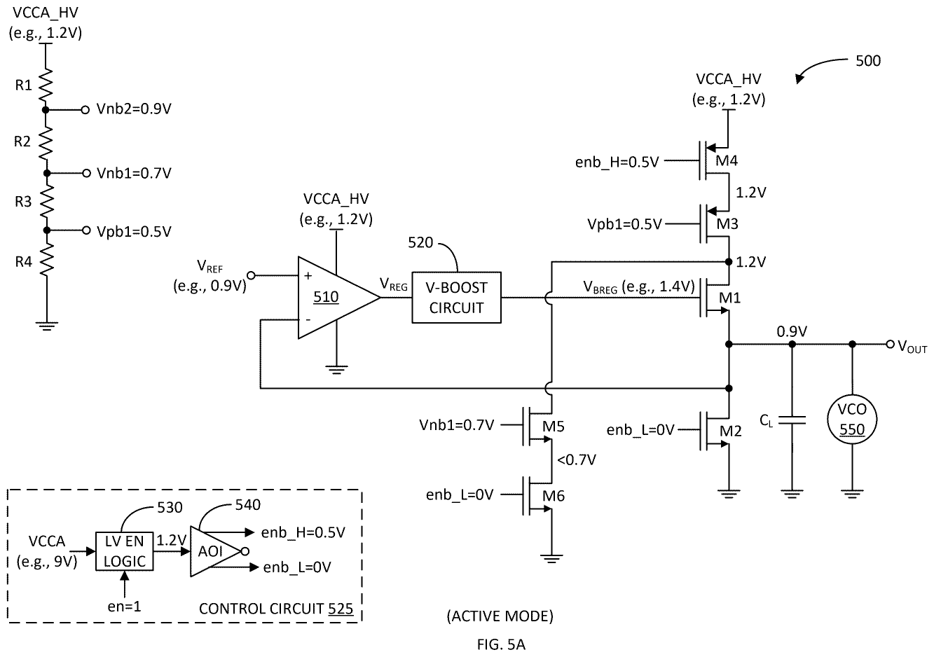

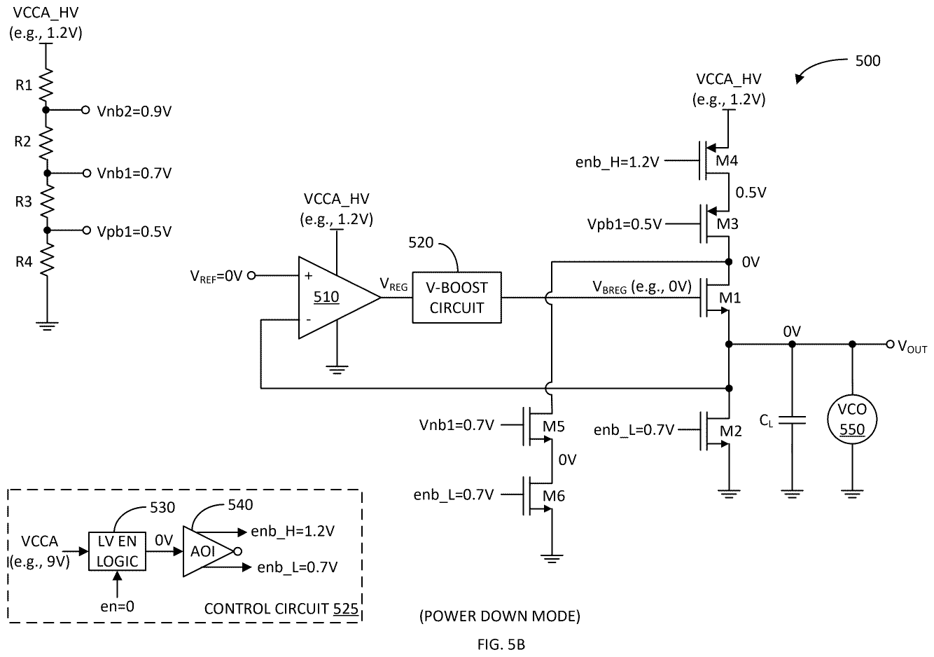

FIG. 5A illustrates a block/schematic diagram of another example low dropout (LDO) voltage regulator 500 in an active mode of operation in accordance with another aspect of the disclosure. The LDO voltage regulator 500 is configured to use only thin oxide devices (e.g., having voltages across their terminals below the reliability of 1.0V) in any mode, such as active mode, power down (PD), VCCA_HV collapse situation, and VCCA collapse situation as discussed in more detail further herein.

The LDO voltage regulator 500 includes an operational amplifier 510, a voltage boost (V-boost) circuit 520, a first protection (switching device) PFET M4, a second protection PFET M3, a pass NFET M1, a power down (PD) NFET M2, a first protection NFET M5, and a second protection (switching device) NFET M6.

The operational amplifier 510, which may be coupled between and receive power from a “high voltage” (HV) upper voltage rail VCCA_HV and a lower voltage rail (e.g., ground), includes a first (e.g., positive) input configured to receive a reference voltage V_{REF} (e.g., 0.9V) for setting an output voltage V_{OUT} of the LDO voltage regulator 500 in active mode. The operational amplifier 510 includes a second (e.g., negative) input coupled to the output of the LDO voltage regulator 500. In such case, the regulated output voltage V_{OUT} is substantially equal to the reference voltage V_{REF} (e.g., 0.9V). However, as discussed with reference to previous implementations, the second (e.g., negative) input of the operational amplifier 510 may be coupled to an intermediate node of a voltage divider including resistors RA and RB coupled in series between the output of the LDO voltage regulator 500 and the lower voltage rail (e.g., ground). In such case, the output voltage V_{OUT} of the LDO voltage regulator 500 may be given by the following relationship: V_{OUT}=V_{REF}*(1+RA/RB), wherein RA and RB also represent the resistances of resistors RA and RB, respectively.

The voltage boost circuit 520 includes an input coupled to an output of the operational amplifier 510 to receive a regulation voltage V_{REG}. The voltage boost circuit 520 is configured to boost the regulation voltage V_{REG} (e.g., <1.2V) to generate a boosted regulation voltage V_{BREG} (e.g., around 1.4V) to drive the pass NFET M1. The first protection PFET M4 includes a source coupled to the VCCA_HV voltage rail, a gate configured to receive a control signal enb_H, and a drain coupled to a source of the second protection PFET M3. The second protection PFET M3 includes a gate configured to receive a first PFET bias voltage Vpb1 (e.g., 0.5V), and a drain coupled to a drain of the pass NFET M1. The pass NFET M1 includes a gate configured to receive the boosted regulation voltage V_{BREG} from the voltage boost circuit 520. The pass NFET M1 includes a source coupled to the output of the LDO voltage regulator 500.

A load (e.g., a VCO 550 and/or other type of circuit and a load capacitor C_{L}) may be coupled between the output of the LDO voltage regulator 500 and the lower voltage rail (e.g., ground). The pull-down (PD) NFET M2 includes a drain coupled to the output of the LDO voltage regulator 500, a gate configured to receive a pull-down (PD) control signal (e.g., may be the same as an enb_L control signal provided to the gate of the second protection NFET M6 as discussed further herein), and a source coupled to the lower voltage rail. The first protection NFET M5 includes a drain coupled to a node between the PFET M3 and the pass NFET M1 (e.g., the drain of the pass NFET M1), a gate configured to receive a first NFET bias voltage Vnb1 (e.g., 0.7V), and a source coupled to a drain of the second protection NFET M6. The second protection NFET M6 includes a gate configured to receive the control signal enb_L, and a source coupled to the lower voltage rail.

The LDO voltage regulator 500 further includes a voltage divider including resistors R1, R2, R3, and R4 coupled in series between the upper voltage rail VCCA_HV and the lower voltage rail. The node between resistors R1 and R2 may be configured to generate a second NFET bias voltage Vnb2 (e.g., 0.9V) used in another implementation of an LDO voltage regulator discussed further herein. The node between resistors R2 and R3 may be configured to generate the first NFET bias voltage Vnb1 (e.g., 0.7V). And, the node between the resistors R3 and R4 may be configured to generate the first PFET bias voltage Vpb1 (e.g., 0.5V).

The LDO voltage regulator 500 further includes a control circuit 525 including level shifter (LV) enable (EN) logic circuit 530 and an always-on dual output inverter (AOI) 540 based on the VCCA_HV supply voltage. The LV EN logic circuit 530 is configured to receive an upper voltage rail VCCA (e.g., 0.9V) and an enable signal (en). In active mode, the LV EN logic circuit 530 is configured to generate a high logic voltage of 1.2V based on an asserted enable signal (en=1). In response to the high logic voltage of 1.2V, the dual output AOI 540 is configured to generate the enb_H control signal at 0.5V, and the enb_L control signal at 0V. As discussed further herein, all FET devices M1-M6, which may be implemented with thin-oxides, meet the reliability limit of 1.0V between any two terminals of the devices.

For example, with regard to the first protection PFET M4, its source is at 1.2V, its gate is at 0.5V, and its drain is at 1.2V as it is turned on. Accordingly, its gate-to-source voltage V_{GS} is 0.7V, its gate-to-drain voltage V_{DS} is also 0.7V, and its source-to-drain voltage V_{DS} is 0V, all within the reliability limit of 1.0V. With regard to the second protection PFET M3, its source is at 1.2V, its gate is at 0.5V, and its drain is at 1.2V as it is also turned on. Accordingly, its gate-to-source voltage V_{GS} is 0.7V, its gate-to-drain voltage V_{DS} is also 0.7V, and its source-to-drain voltage V_{DS} is 0V, all within the reliability limit of 1.0V.

With regard to the pass NFET M1, its drain is at 1.2V, its gate is at 1.4V, and its source is at 0.9V. Accordingly, its gate-to-drain voltage V_{GD} is 0.2V, its gate-to-source voltage V_{GS} is 0.5V, and its drain-to-source voltage V_{DS} is 0.3V, all within the reliability limit of 1.0V. With regard to the pull-down (PD) NFET M2, its drain is at 0.9V, its gate is at 0V, and its source is at 0V as it is turned off. Accordingly, its gate-to-drain voltage V_{GD} is 0.9V, its gate-to-source voltage V_{GS} is also 0V, and its drain-to-source voltage V_{DS} is 0.9V, all within the reliability limit of 1.0V.

With regard to the first protection NFET M5, its drain is at 1.2V, its gate is at 0.7V, and its source is around 0.7V as it is turned off due to the turned-off protection NFET M6. Accordingly, its gate-to-drain voltage V_{GD} is 0.5V, its gate-to-source voltage V_{GS} is around 0V, and its drain-to-source voltage V_{DS} is 0.5V, all within the reliability limit of 1.0V. With regard to the second protection NFET M6, its drain is around 0.7V, its gate is at 0V, and its source is at 0V. Accordingly, its gate-to-drain voltage V_{GD} is around 0.7V, its gate-to-source voltage V_{GS} is also 0V, and its drain-to-source voltage V_{DS} is around 0.7V, all within the reliability limit of 1.0V.

FIG. 5B illustrates a block/schematic diagram of the example LDO voltage regulator 500 in a power down (PD) mode of operation in accordance with another aspect of the disclosure. In the power down mode, the enable signal provided to the LV EN logic circuit 530 of the control circuit 525 is deasserted (en=0). In response, the LV EN logic circuit 530 generates a logic zero (0) (e.g., 0V). In response to the 0V, the dual output AOI 540 generates the control signal enb_H at 1.2V and the control signal enb_L at 0.7V.

With regard to the first protection PFET M4, its source is at 1.2V, its gate is at 1.2V, and its drain is at 0.5V (as PFET M4 is turned off and its drain is at substantially the gate of the second protection PFET M3). Accordingly, its gate-to-source voltage V_{GS} is 0V, its gate-to-drain voltage V_{DS} is 0.7V, and its source-to-drain voltage V_{DS} is 0.7V, all within the reliability limit of 1.0V. With regard to the second protection PFET M3, its source is at 0.5V (as discussed), its gate is at 0.5V (also as discussed), and its drain is at 0V as the protection PFETs M3 and M4 are both turned off. Accordingly, its gate-to-source voltage V_{GS} is 0V, its gate-to-drain voltage V_{DS} is 0.5V, and its source-to-drain voltage V_{DS} is 0.5V, all within the reliability limit of 1.0V.

With regard to the pass NFET M1, its drain is at 0V, its gate is at 0V, and its source is at 0V. Accordingly, its gate-to-drain voltage V_{GD} is 0V, its gate-to-source voltage V_{GS} is also 0V, and its drain-to-source voltage V_{DS} is 0V, all within the reliability limit of 1.0V. With regard to the pull-down (PD) NFET M2, its drain is at 0V, its gate is at 0.7V, and its source is at 0V as NFET M2 is turned on. Accordingly, its gate-to-drain voltage V_{GD} is 0.7V, its gate-to-source voltage V_{GS} is also 0.7V, and its drain-to-source voltage V_{DS} is 0V, all within the reliability limit of 1.0V.

With regard to the first protection NFET M5, its drain is at 0V, its gate is at 0.7V, and its source is 0V as it is turned on due to the turned-on protection NFET M6. Accordingly, its gate-to-drain voltage V_{GD} is 0.7V, its gate-to-source voltage V_{GS} is 0.7V, and its drain-to-source voltage V_{DS} is 0V, all within the reliability limit of 1.0V. With regard to the second protection NFET M6, its drain is around 0V, its gate is at 0.7V, and its source is at 0V as it is turned on. Accordingly, its gate-to-drain voltage V_{GD} is around 0.7V, its gate-to-source voltage V_{GS} is also 0.7V, and its drain-to-source voltage V_{DS} is around 0V, all within the reliability limit of 1.0V.

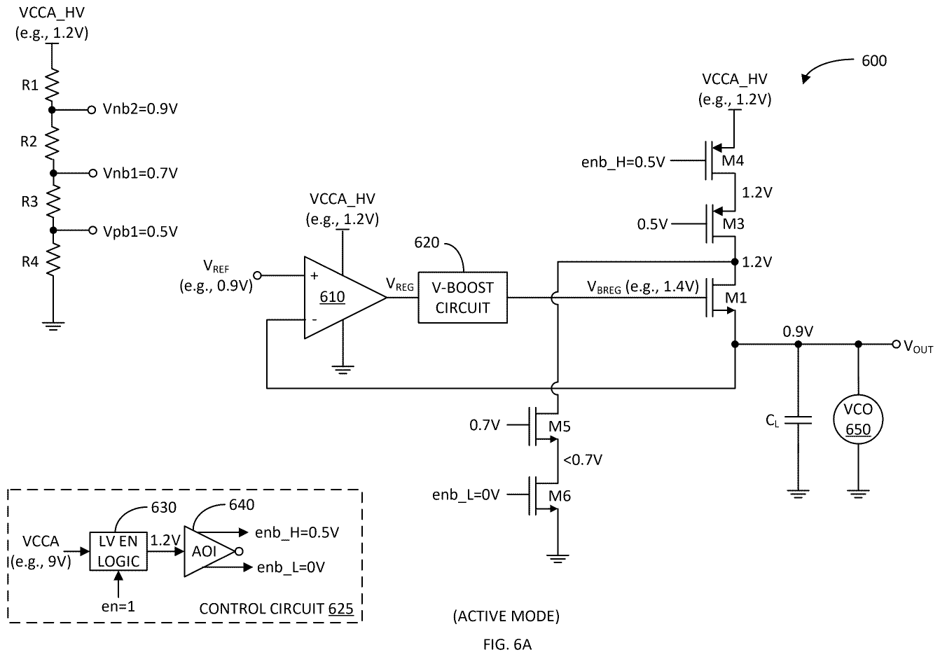

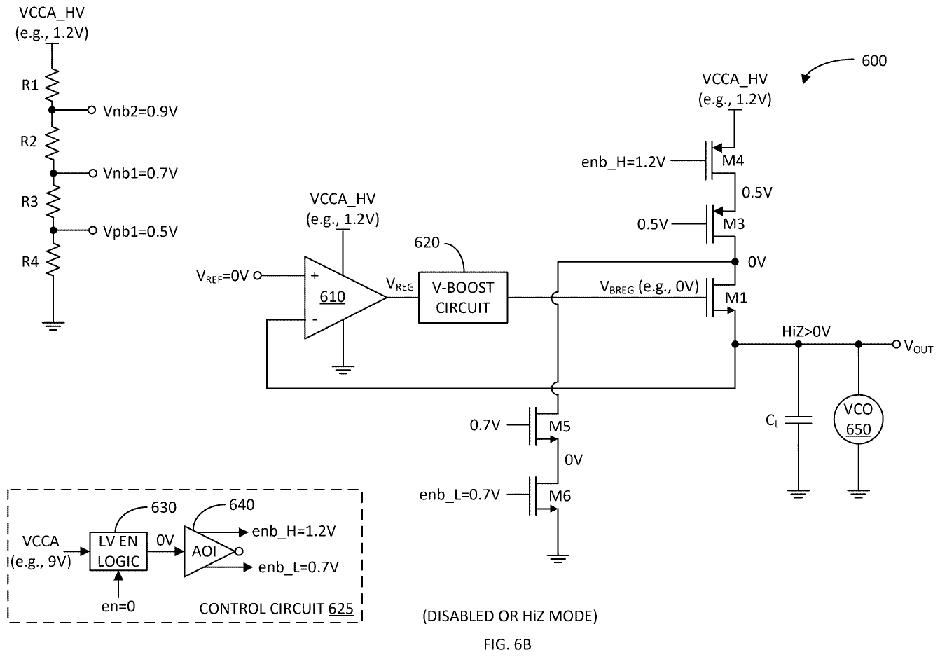

FIG. 6A illustrates a block/schematic diagram of another example LDO voltage regulator 600 in an active mode of operation in accordance with another aspect of the disclosure. The LDO voltage regulator 600 is similar to that of LDO voltage regulator 500 and includes many of the same/similar elements as indicated by the same reference identifiers and the reference numbers having their most significant digit as a “6” for LDO voltage regulator 600 instead of a “5” for LDO voltage regulator 500.

The LDO voltage regulator 600 differs from LDO voltage regulator 500 in that it does not include the pull-down NFET M2. As discussed further herein, in disable or HiZ mode, the output of the LDO voltage regulator 600 is at a high impedance (HiZ) or floating. However, the remaining FETs are still protected from overvoltage in active mode and HiZ mode as discussed further herein. In active mode, the control circuit 625 and the voltage divider R1-R4 operate substantially the same as the control circuit 525 and voltage divider R1-R4 of LDO voltage regulator 500 in active mode. Accordingly, the LDO voltage regulator 600 has substantially the same voltage potentials across FETs M1 and M3-M6 as the corresponding FET devices M1 and M3-M6 of LDO voltage regulator 500 in active mode as previously discussed.

FIG. 6B illustrates a block/schematic diagram of the example low dropout (LDO) voltage regulator 600 in a disabled or HiZ mode of operation in accordance with another aspect of the disclosure. In disabled or HiZ mode, the control circuit 625 and the voltage divider R1-R4 operate substantially the same as the control circuit 525 and voltage divider R1-R4 of LDO voltage regulator 500. Accordingly, the LDO voltage regulator 600 has substantially the same voltage potentials across FET devices M1 and M3-M6 as the corresponding FET devices M1 and M3-M6 of LDO voltage regulator 500 in HiZ mode with perhaps the exception of the gate-to-source V_{GS} of the pass NFET M1. As the output of the LDO voltage regulator 600 is at high impedance or floating, the output voltage V_{OUT} may settle to something above 0V (e.g., 0.2-0.4V), but still well within the reliability of 1.0V for all terminals of the pass NFET M1.

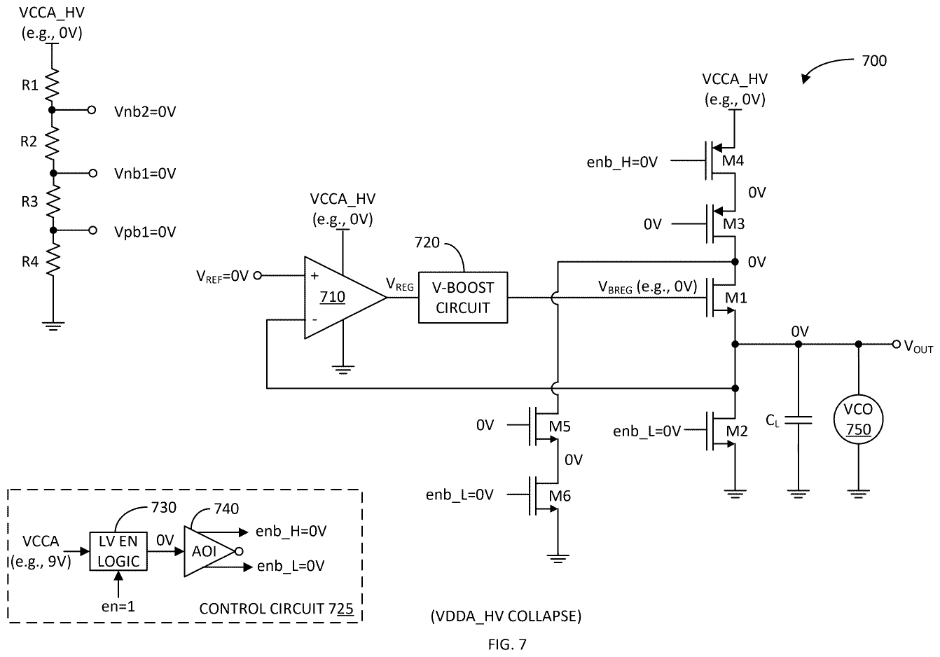

FIG. 7 illustrates a block/schematic diagram of another example LDO voltage regulator 700 in a VCCA_HV upper voltage rail collapse situation in accordance with another aspect of the disclosure. The LDO voltage regulator 700 is similar to that of LDO voltage regulator 500 and includes the same/similar elements as indicated by the same reference identifiers and numbers with the exception that their most significant digit is a “7” for LDO voltage regulator 700 instead of a “5” for LDO voltage regulator 500. When the VCCA_HV collapses, all voltages at all nodes of the LDO voltage regulator 700 settle to zero (0)V. Thus, there are no reliability issues when the VCCA_HV collapses.

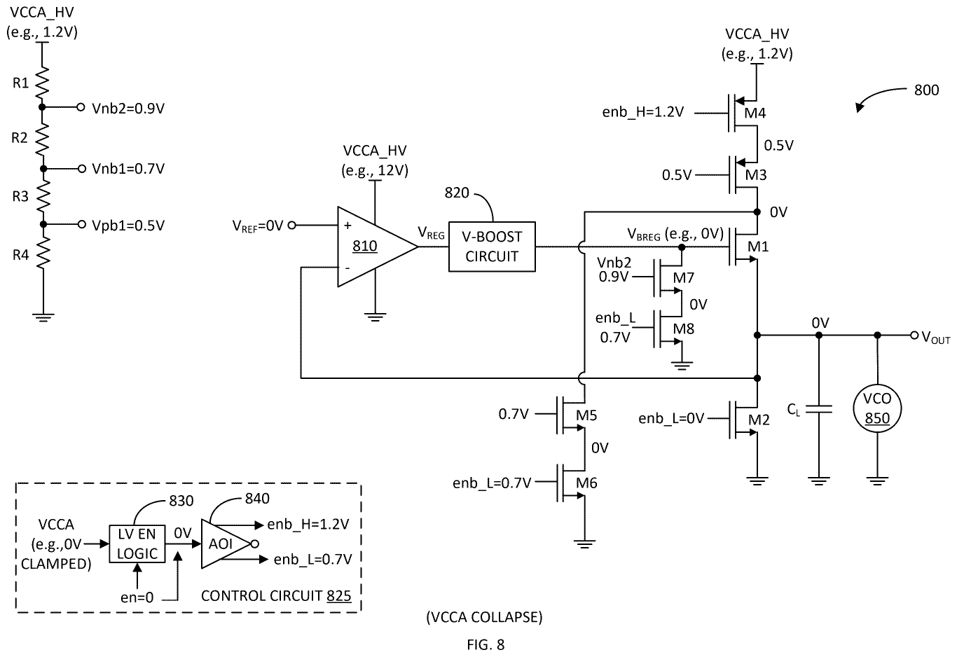

FIG. 8 illustrates a block/schematic diagram of another example low dropout (LDO) voltage regulator 800 in a VCCA collapse situation in accordance with another aspect of the disclosure. The LDO voltage regulator 800 is similar to that of LDO voltage regulator 500 and includes the same/similar elements as indicated by the same reference identifiers and numbers with the exception that their most significant digit is a “8” for LDO voltage regulator 800 instead of a “5” for LDO voltage regulator 500.

The LDO voltage regulator 800 differs from LDO voltage regulator 500 in that it further includes two more protection NFETs M7 and M8, both are thin-oxide devices. The protection NFETs M7 and M8 are coupled in series between the gate of the pass NFET M1 and the lower voltage rail (e.g., ground). More specifically, the protection NFET M7 includes a drain coupled to the gate of pass NFET M1, a gate configured to receive the second NFET bias voltage Vnb2=0.9V from the voltage divider R1-R4 (e.g., at a node between R1 and R2), and a source coupled to a drain of the protection NFET M8. The protection NFET M8 includes a gate configured to receive the NFET control voltage enb_L=0.7V, and a source coupled to the lower voltage rail.

When the VCCA voltage collapse, the VCCA voltage is clamped to 0V and the output of the LV EN logic circuit 830 is also clamped to 0V. The dual output AOI 840, in turn, inverts the 0V logic voltage to generate the control signal enb_H at 1.2V and the control signal enb_L at 0.7V. In this regard, the LDO voltage regulator 800 is configured per the power down (PD) mode of LDO voltage regulator 500 as shown in FIG. 5B. Thus, NFETs M1-M6 are all within their reliability limit of 1.0V.

With regard to the additional protection NFETs M7 and M8, they both meet the reliability limit of 1.0V. For example, the NFET M7 has a drain voltage at 0V, a gate voltage at Vnb 2=0.9V, and a drain at 0V as both NFETs M7-M8 are turned on. Accordingly, the NFET M7 has a gate-to-drain voltage V_{DG} of 0.9V, a gate-to-source voltage V_{GS} of 0.9V, and a drain-to-source voltage V_{GS} of 0V. Similarly, the NFET M8 includes a gate voltage at enb_L=0.7V and a source at 0V. Accordingly, the NFET M8 has a gate-to-drain voltage V_{DG} of 0.7V, a gate-to-source voltage V_{GS} of 0.7V, and a drain-to-source voltage V_{GS} of 0V.

For the sake of completeness, in active mode with regard to NFETs M7 and M8 (not explicitly shown), both the NFETs M7 and M8 are within the reliability of 1.0V. As previously discussed, in active mode, the gate of the pass NFET M1 is around 1.4V. Thus, the NFET M7 has a drain voltage at 1.4V, a gate voltage at Vnb 2=0.9V, and a source at 0.9V as NFET M8 is turned off. Accordingly, the NFET M7 has a gate-to-drain voltage V_{DG} of 0.5V, a gate-to-source voltage V_{GS} of 0V, and a drain-to-source voltage V_{GS} of 0.5V. Similarly, the NFET M8 includes a gate voltage at enb_L=0V and a source at 0V. Accordingly, the NFET M8 has a gate-to-drain voltage V_{DG} of 0.9V, a gate-to-source voltage V_{GS} of 0V, and a drain-to-source voltage V_{GS} of 0.9V.

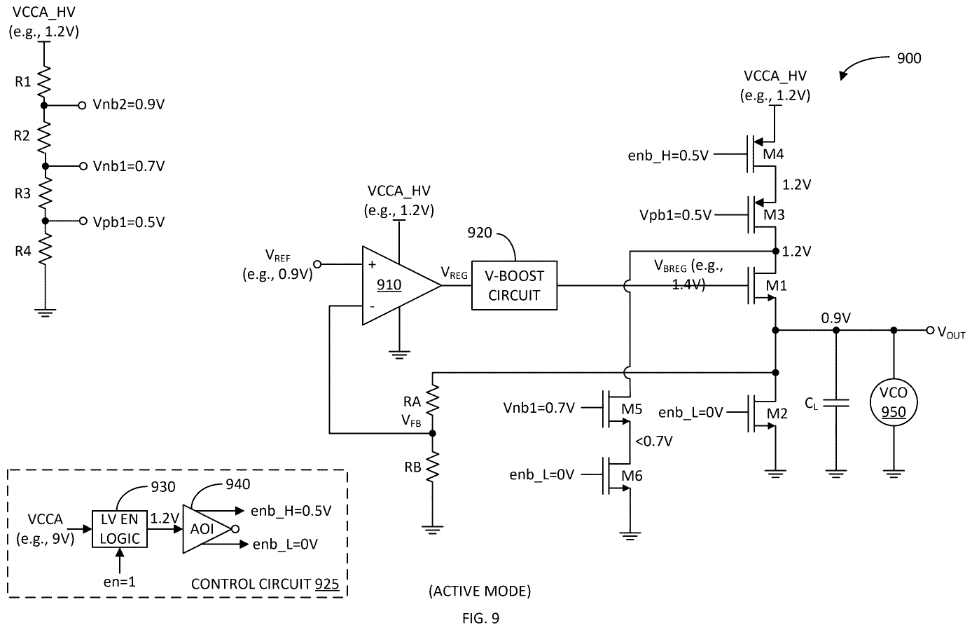

FIG. 9 illustrates a block/schematic diagram of another example LDO voltage regulator 900 in an active mode of operation in accordance with another aspect of the disclosure. The LDO voltage regulator 900 is similar to that of LDO voltage regulator 500 and includes many of the same/similar elements as indicated by the same reference identifiers and the reference numbers having their most significant digit as a “9” for LDO voltage regulator 900 instead of a “5” for LDO voltage regulator 500.

The LDO voltage regulator 900 differs from LDO voltage regulator 500 in that it further includes a voltage divider including resistors RA and RB coupled in series between the output of the LDO voltage regulator 900 and the lower voltage rail (e.g., ground). The operational amplifier 910 includes a second (e.g., negative) input coupled to an intermediate node between resistors RA and RB. As previously discussed, the output voltage V_{OUT} is related to the reference voltage V_{REF} in accordance with the following equation: V_{OUT}=V_{REF}*(1+RA/RB), where RA and RB are also the resistances of the resistors RA and RB, respectively.

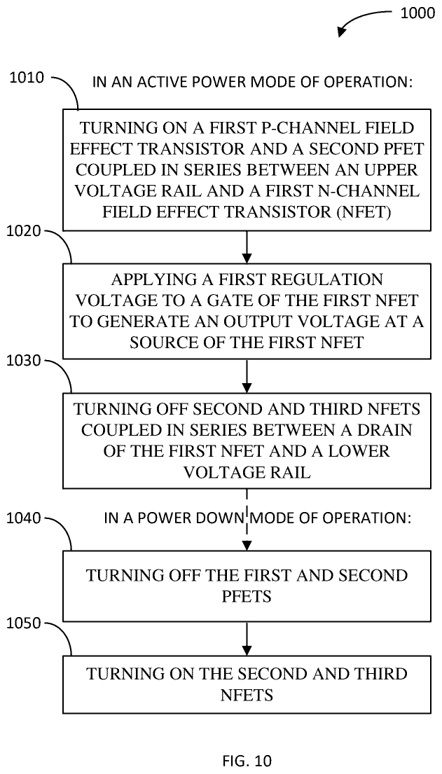

FIG. 10 illustrates a flow diagram of an example method 1000 of generating an output voltage in accordance with another aspect of the disclosure. The method 1000 includes in an active mode of operation: turning on a first p-channel field effect transistor and a second PFET coupled in series between an upper voltage rail and a first n-channel field effect transistor (NFET) (block 1010); applying a first regulation voltage to a gate of the first NFET to generate the output voltage at a source of the first NFET (block 1020); and turning off second and third NFETs coupled in series between a drain of the first NFET and a lower voltage rail (block 1030). The method 1000 further includes in a power down mode of operation: turning off the first and second PFETs (block 1040); and turning on the second and third NFETs (block 1050).

The following provides an overview of aspects of the present disclosure:
Aspect 1: A low dropout (LDO) voltage regulator, comprising: a first p-channel field effect transistor (PFET) including a gate configured to receive a first control signal; a second PFET including a gate configured to receive a first bias voltage; a first n-channel field effect transistor (NFET), wherein the first PFET, the second PFET, and the first NFET are coupled in series between a first upper voltage rail and an output of the LDO voltage regulator; an operational amplifier including a first input configured to receive a reference voltage; a voltage boost circuit including an input coupled to an output of the operational amplifier and an output coupled to a gate of the first NFET; a second NFET including a gate configured to receive a second bias voltage; and a third NFET coupled in series with the second NFET between a node a lower voltage rail, wherein the node is between the second PFET and the first NFET, wherein the third NFET includes a gate configured to receive a second control signal.
Aspect 2: The LDO voltage regulator of aspect 1, wherein the operational amplifier includes a second input coupled to the output of the LDO voltage regulator.
Aspect 3: The LDO voltage regulator of aspect 1 or 2, further comprising a first resistor and a second resistor coupled in series between the output of the LDO voltage regulator and the lower voltage rail, wherein the operational amplifier includes a second input coupled to a node between the first resistor and the second resistor.
Aspect 4: The LDO voltage regulator of any one of aspects 1-3, further comprising a fourth NFET coupled between the output of the LDO voltage regulator and the lower voltage rail, wherein the fourth NFET includes a gate configured to receive the second control signal.
Aspect 5: The LDO voltage regulator of any one of aspects 1-4, further comprising: a fourth NFET including a gate configured to receive a third bias voltage; and a fifth NFET coupled in series with the fourth NFET between the gate of the first NFET and the lower voltage rail, wherein the fifth NFET includes a gate configured to receive the second control signal.
Aspect 6: The LDO voltage regulator of any one of aspects 1-5, further comprising a control circuit configured to generate the first control signal and the second control signal.
Aspect 7: The LDO voltage regulator of aspect 6, wherein the control circuit comprises a dual output inverter configured to generate the first and second control signals based on an input logic signal.
Aspect 8: The LDO voltage regulator of aspect 7, wherein the first upper voltage rail is configured to receive a first supply voltage, wherein the control circuit further includes a level shifter enable logic circuit 530 configured to generate the logic signal based on a second supply voltage and an enable signal, wherein the second supply voltage is lower than the first supply voltage.
Aspect 9: The LDO voltage regulator of any one of aspects 1-8, further comprising a set of resistors coupled in series between the first upper voltage rail and the lower voltage rail, wherein two nodes between distinct ones of the set of resistors are configured to generate the first and second bias voltages, respectively.
Aspect 10: The LDO voltage regulator of any one of aspects 1-9, wherein in an active mode of operation: the first control signal and the first bias voltage are configured to turn on the first and second PFETs, respectively; and the second bias voltage and the second control signal are configured to turn off the second and third NFETs, respectively.
Aspect 11: The LDO voltage regulator of any one of aspects 1-10, wherein in a power down mode of operation: the first control signal and the first bias voltage are configured to turn off the first and second PFETs, respectively; and the second bias voltage and the second control signal are configured to turn on the second and third NFETs, respectively.
Aspect 12: The LDO voltage regulator of any one of aspects 1-11, wherein in a power down mode of operation: the first control signal and the first bias voltage are configured to turn off the first and second PFETs, respectively; and the second bias voltage and the second control signal are configured to turn on the second and third NFETs, respectively.
Aspect 13: The LDO voltage regulator of aspect 12, further comprising a fourth NFET coupled between the output of the LDO voltage regulator and the lower voltage rail, wherein the second control signal is configured to turn on the fourth NFET in the power down mode of operation.
Aspect 14: The LDO voltage regulator of any one of aspects 1-13, wherein the first upper voltage rail is configured to receive a first supply voltage, and further comprising a control circuit configured to generate the first control signal and the second control signal based on a second supply voltage, wherein the first control signal is configured to turn off the first and second PFETs and the second control signal is configured to turn on the second and third NFETs in response to the second supply voltage collapsing.
Aspect 15: A method of generating an output voltage, comprising: in an active mode of operation: turning on a first p-channel field effect transistor (PFET) and a second PFET coupled in series between an upper voltage rail and a first n-channel field effect transistor (NFET); applying a first regulation voltage to a gate of the first NFET to generate the output voltage at a source of the first NFET; and turning off second and third NFETs coupled in series between a drain of the first NFET and a lower voltage rail; and in a power down mode of operation: turning off the first and second PFETs; and turning on the second and third NFETs.
Aspect 16: The method of aspect 15, further comprising generating the first regulation voltage based on a reference voltage and the output voltage.
Aspect 17: The method of aspect 16, wherein generating the first regulation voltage comprises: generating a second regulation voltage based on the reference voltage and the output voltage; and boosting the second regulation voltage to generate the first regulation voltage.
Aspect 18: The method of aspect 16 or 17, further comprising: voltage dividing the output voltage to generate a feedback voltage; and generating the first regulation voltage based on the feedback voltage and the reference voltage.
Aspect 19: The method of any one of aspects 15-18, further comprising: turning on a fourth NFET to pull down the output voltage to zero (0) Volt in response to the power down mode of operation; and turning off the fourth NFET in response to the active mode of operation.
Aspect 20: The method of any one of aspects 15-19, further comprising: turning on fourth and fifth NFETs to pull-down the first regulation voltage at the gate of the first NFET in response to the power down mode of operation; and turning off the fourth and fifth NFETs in response to the active mode of operation.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. A low dropout (LDO) voltage regulator, comprising:
a first p-channel field effect transistor (PFET) including a gate configured to receive a first control signal;
a second PFET including a gate configured to receive a first bias voltage;
a first n-channel field effect transistor (NFET), wherein the first PFET, the second PFET, and the first NFET are coupled in series between a first upper voltage rail and an output of the LDO voltage regulator;
an operational amplifier including a first input configured to receive a reference voltage;
a voltage boost circuit including an input coupled to an output of the operational amplifier and an output coupled to a gate of the first NFET;
a second NFET including a gate configured to receive a second bias voltage; and
a third NFET coupled in series with the second NFET between a node a lower voltage rail, wherein the node is between the second PFET and the first NFET, wherein the third NFET includes a gate configured to receive a second control signal.

2. The LDO voltage regulator of claim 1, wherein the operational amplifier includes a second input coupled to the output of the LDO voltage regulator.

3. The LDO voltage regulator of claim 1, further comprising a first resistor and a second resistor coupled in series between the output of the LDO voltage regulator and the lower voltage rail, wherein the operational amplifier includes a second input coupled to a node between the first resistor and the second resistor.

4. The LDO voltage regulator of claim 1, further comprising a fourth NFET coupled between the output of the LDO voltage regulator and the lower voltage rail, wherein the fourth NFET includes a gate configured to receive the second control signal.

5. The LDO voltage regulator of claim 1, further comprising:
a fourth NFET including a gate configured to receive a third bias voltage; and
a fifth NFET coupled in series with the fourth NFET between the gate of the first NFET and the lower voltage rail, wherein the fifth NFET includes a gate configured to receive the second control signal.

6. The LDO voltage regulator of claim 1, further comprising a control circuit configured to generate the first control signal and the second control signal.

7. The LDO voltage regulator of claim 6, wherein the control circuit comprises a dual output inverter configured to generate the first and second control signals based on a logic signal.

8. The LDO voltage regulator of claim 7, wherein the first upper voltage rail is configured to receive a first supply voltage, wherein the control circuit further includes a level shifter enable logic circuit 530 configured to generate the logic signal based on a second supply voltage and an enable signal, wherein the second supply voltage is lower than the first supply voltage.

9. The LDO voltage regulator of claim 1, further comprising a set of resistors coupled in series between the first upper voltage rail and the lower voltage rail, wherein two nodes between distinct ones of the set of resistors are configured to generate the first and second bias voltages, respectively.

10. The LDO voltage regulator of claim 1, wherein in an active mode of operation:
the first control signal and the first bias voltage are configured to turn on the first and second PFETs, respectively; and
the second bias voltage and the second control signal are configured to turn off the second and third NFETs, respectively.

11. The LDO voltage regulator of claim 10, further comprising a fourth NFET coupled between the output of the LDO voltage regulator and the lower voltage rail, wherein the second control signal is configured to turn off the fourth NFET in the active mode of operation.

12. The LDO voltage regulator of claim 1, wherein in a power down mode of operation:
the first control signal and the first bias voltage are configured to turn off the first and second PFETs, respectively; and
the second bias voltage and the second control signal are configured to turn on the second and third NFETs, respectively.

13. The LDO voltage regulator of claim 12, further comprising a fourth NFET coupled between the output of the LDO voltage regulator and the lower voltage rail, wherein the second control signal is configured to turn on the fourth NFET in the power down mode of operation.

14. The LDO voltage regulator of claim 1, wherein the first upper voltage rail is configured to receive a first supply voltage, and further comprising a control circuit configured to generate the first control signal and the second control signal based on a second supply voltage, wherein the first control signal is configured to turn off the first and second PFETs and the second control signal is configured to turn on the second and third NFETs in response to the second supply voltage collapsing.

15. A method of generating an output voltage, comprising:
in an active mode of operation:
turning on a first p-channel field effect transistor (PFET) and a second PFET coupled in series between an upper voltage rail and a first n-channel field effect transistor (NFET);
applying a first regulation voltage to a gate of the first NFET to generate the output voltage at a source of the first NFET; and
turning off second and third NFETs coupled in series between a drain of the first NFET and a lower voltage rail; and
in a power down mode of operation:
turning off the first and second PFETs; and
turning on the second and third NFETs.

16. The method of claim 15, further comprising generating the first regulation voltage based on a reference voltage and the output voltage.

17. The method of claim 16, wherein generating the first regulation voltage comprises:
generating a second regulation voltage based on the reference voltage and the output voltage; and
boosting the second regulation voltage to generate the first regulation voltage.

18. The method of claim 16, further comprising:
voltage dividing the output voltage to generate a feedback voltage; and
generating the first regulation voltage based on the feedback voltage and the reference voltage.

19. The method of claim 15, further comprising:
turning on a fourth NFET to pull down the output voltage to zero (0) Volt in response to the power down mode of operation; and
turning off the fourth NFET in response to the active mode of operation.

20. The method of claim 15, further comprising:
turning on fourth and fifth NFETs to pull-down the first regulation voltage at the gate of the first NFET in response to the power down mode of operation; and
turning off the fourth and fifth NFETs in response to the active mode of operation.
